(19) United States
(12) Patent Application Publication
(10) Pub. No.: US 2013/0299735 A1
(43) Pub. Date: Nov. 14, 2013

(54) METHOD OF PRODUCING NANOCOMPOSITE CATHODE ACTIVE MATERIAL FOR LITHIUM SECONDARY BATTERY

(71) Applicant: KOREA INSTITUTE OF SCIENCE AND TECHNOLOGY, Seoul (KR)

(72) Inventors: Kyung Yoon CHUNG, Seoul (KR); Byung Won CHO, Seoul (KR); Won Young CHANG, Seoul (KR); Jae Hyung CHO, Gyeonggi-do (KR); Jae-kyo NOH, Seoul (KR); Soo KIM, Daejeon (KR); Sujin KIM, Seoul (KR)

(73) Assignee: Korea Institute of Science and Technology, Seoul (KR)

(21) Appl. No.: 13/853,141

(22) Filed: Mar. 29, 2013

(30) Foreign Application Priority Data
May 8, 2012 (KR) 10-2012-0048634

(51) Int. Cl. H01M 4/04

(52) U.S. Cl. CPC H01M 4/0497
USPC 252/182.1

(57) ABSTRACT

Disclosed is a method of producing a nanocomposite cathode active material for a lithium secondary battery, represented by the following formula:

xLi₂MnO₃—(1−x)LiMO₂

wherein M is Niₐ—Mn_{b}—Co_{c}, x is a decimal number from 0.1 to 0.9, and a, b and c are independently a decimal number from 0.05 to 0.9. The method includes mixing a lithium compound with a manganese compound to prepare Li₂MnO₃ as a first cathode active material, mixing a mixed solution of nickel sulfate/manganese sulfate/cobalt sulfate, a sodium hydroxide solution and aqueous ammonia to prepare a coprecipitated hydroxide represented by (Niₐ—Mn_{b}—Co_{c})(OH)₂ wherein a, b and c are as defined above, mixing the coprecipitated hydroxide with a lithium compound to prepare a second cathode active material represented by LiMO₂ wherein M is as defined above, and mixing the first cathode active material with the second cathode active material. The nanocomposite cathode active material has improved electrochemical properties, such as stability, electrode capacity and cycle life in the high-voltage region.

### CROSS-REFERENCE TO RELATED APPLICATIONS

This application claims priority under 35 U.S.C. §119 to Korean Patent Application No. 10-2012-0048634 filed on May 8, 2012, in the Korean Intellectual Property Office, the disclosure of which is incorporated herein by reference in its entirety.

### BACKGROUND OF THE INVENTION

1. Field of the Invention

The present invention relates to a method of producing a nanocomposite cathode active material for a lithium secondary battery that has improved electrochemical properties, such as stability, electrode capacity and cycle life in the high-voltage region.

2. Description of the Related Art

Lithium secondary batteries with high energy density are widely used at present as power sources in information and communication technology devices, such as portable computers, mobile phones, and cameras.

Recent efforts to reduce reliance on oil and basically mitigate greenhouse gas emissions have led to the competitive development of plug-in hybrid electric vehicles (PHEVs) and electric vehicles employing lithium secondary batteries as energy sources.

Examples of layered metal oxide cathode active materials for lithium secondary batteries include LiCoO₂, LiNiO₂, LiNiₓCo₁₋ₓO₂ (0<x<1), and LiNi_{1-x-y}CoₓM_{y}O₂ (0<x<1.0<y<1, 0<x+y<1, M=metal selected from Al, Sr, Mg, Fe and Mn). Of these, LiCoO₂ is most widely used in commercial lithium secondary batteries due to its high capacity, low self-discharge rate and long cycle life. However, it was reported that Li₁₋ₓCoO₂ (x>0.5) undergoes a dramatic decrease in capacity with increasing number of cycles despite its high theoretical capacity.

The theoretical capacity of Li₁₋ₓCoO₂ is 274 mAh/g but the actual capacity thereof is only 145 mAh/g, which corresponds to about 53% of the theoretical capacity. The charge voltage of an electrode corresponding to the actual capacity is equivalent to 4.1 to 4.2 V.

Recently, there has been an increasing demand for cathode active materials with high energy density that can find application in electric vehicles. Under such circumstances, a metal oxide represented by Li_{1+y}M_{1-y}O₂ (M=Ni—Mn—Co) has attracted a lot of attention as a cathode active material. The compound Li_{1+y}M_{1-y}O₂ is prepared by mixing (Ni—Mn—Co)(OH)₂ as a coprecipitated hydroxide with an excess of a lithium compound (molar ratio 1:≧1), and heat treating the mixture. However, new compositions of Li_{1+y}M_{1-y}O₂ are difficult to synthesize, implying that the compound is limited in capacity and cycle life.

Charging of layered oxides, such as Li_{1+y}M_{1-y}O₂, with 4.3 V or above causes problems such as dissolution of transition metals and site inversion between lithium ions and transition metal ions, bringing about a considerable reduction in reversible capacity. Further, surface structure degradation and rapid structural collapse of Li_{1+y}M_{1-y}O₂ after lithium deintercalation accompany exothermic reactions which cause serious problems in terms of battery stability.

In order to overcome the above problems, attempts have been made to achieve high structural stability of active materials by the addition of trace amounts of hetero elements or research has been conducted to inhibit the dissolution of metal ions by the surface modification of active materials.

As an example, coating of a metal oxide, such as ZrO₂ or Al₂O₃, and a metal composite oxide on the surface of an electrode active material is considered to enhance the stability of the electrode active material against high voltage, resulting in an increase in reversible capacity. Specifically, surface coating of a cathode active material inhibits dissolution of a transition metal from the surface of the cathode active material or enhances the surface stability of the cathode active material at high voltage to suppress the occurrence of side reactions on the surface of the cathode active material. As a result of the surface coating, the cathode active material can be charged and discharged with high voltage, ensuring a higher capacity than conventional cathode active materials. However, the surface coating of the cathode active material is cost- and time-consuming.

As another example, surface modification of an electrode active material is considered to improve the cycle efficiency and thermal stability of the electrode active material at high-rate discharge. The surface modification also enables the electrode active material to high capacity and high output at high-rate discharge while at the same time achieving remarkably improved life. However, the addition of a material for the surface modification may lead to a decrease in specific capacity. When the material for surface modification has a low ionic conductivity, the mobility of lithium ions is impeded during charge/discharge, resulting in low rate performance. Further, the surface modification decreases the area for the intercalation/deintercalation reactions of lithium on the surface of a cathode active material, leading to deterioration of high-rate characteristics.

Thus, there is a need for a cathode active material that has improved discharge capacity, cycle efficiency and stability even without undergoing coating and surface modification.

### SUMMARY OF THE INVENTION

It is an object of the present invention to provide a method of producing a nanocomposite cathode active material for a lithium secondary battery that has improved electrochemical properties, such as stability, electrode capacity and cycle life in the high-voltage region.

According to the present invention, there is provided a method of producing a nanocomposite cathode active material for a lithium secondary battery, represented by the following formula:

xLi₂MnO₃—(1−x)LiMO₂

wherein M is Niₐ—Mn_{b}—Co_{c}, x is a decimal number from 0.1 to 0.9, and a, b and c are independently a decimal number from 0.05 to 0.9, with the proviso that the sum of a, b and c is equal to 1,

the method including (a) mixing a lithium compound with a manganese compound, and heat treating the mixture to prepare Li₂MnO₃ as a first cathode active material, (b) mixing a mixed solution of nickel sulfate/manganese sulfate/cobalt sulfate, a sodium hydroxide solution and aqueous ammonia to prepare a coprecipitated hydroxide represented by (Niₐ—Mn_{b}—Co_{c})(OH)₂ where a, b and c are as defined above, (c) mixing the coprecipitated hydroxide with a lithium compound, and heat treating the mixture to prepare a second cathode active material represented by LiMO₂ where M is as defined above, and (d) mixing the first cathode active material with the second cathode active material, and heat treating the mixture.

In step (a), at least one dopant selected from the group consisting of Mg, Al,

Ca, Ti, V, Cr, Fe, Cu, Zn, Ga, Zr, Mo, Sn, Sb, W and Bi may be added in an amount of 0.01 to 2% by mole, based on the total moles of the first cathode active material Li₂MnO₃.

In step (a), the heat treatment is performed at 400 to 900° C. for 3 to 24 hours.

In step (b), the molarity of the sodium hydroxide solution is 1.5 to 4 times higher than that of the mixed solution, and the pH is maintained at 11 to 12.

The method of the present invention may further include washing, filtering and drying the coprecipitated hydroxide after step (b). In this case, the water content of the dried coprecipitated hydroxide is preferably adjusted to 10% or less.

In step (c), at least one dopant selected from the group consisting of Mg, Al, Ca, Ti, V, Cr, Fe, Cu, Zn, Ga, Zr, Mo, Sn, Sb, W and Bi may be added in an amount of 0.01 to 2% by mole, based on the total moles of the second cathode active material, and the heat treatment is performed at 400 to 900° C. form 3 to 24 hours.

In step (d), the heat treatment is performed at 900 to 1100° C. form 3 to 24 hours.

The lithium compounds are Li₂CO₃ or LiOH, and the manganese compound is selected from the group consisting of Mn₂O₃, MnO₂, MnO, Mn₃O₄, Mn(OH)₂ and mixtures thereof.

The nanocomposite cathode active material produced in step (d) has an average particle diameter of 10 to 100 nm, and the nanocomposite cathode active material having an average particle diameter of 10 to 80 nm may account for at least 70% by weight of the total weight of the nanocomposite cathode active material.

The method of the present invention enables the production of a cathode active material having a desired composition. Therefore, the discharge capacity and cycle life characteristics of the cathode active material can be freely controlled.

In addition, the method of the present invention can provide a nanocomposite cathode active material that has improved electrochemical properties, such as stability, electrode capacity and cycle life in the high-voltage region.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a high-resolution transmission electron microscopy (HRTEM) image of a nanocomposite cathode active material produced in Example 1;

FIG. 2 shows energy dispersive X-ray spectra (EDS) of a nanocomposite cathode active material produced in Example 1;

FIG. 3A is a graph that compares discharge capacities of Example 1 and Comparative Examples 1-3;

FIG. 3B is a graph that compares cycle lives of Example 1 and Comparative Examples 1-3;

FIG. 4A is a graph that compares discharge capacities of Example 2 and Comparative Example 4;

FIG. 4B is a graph that compares cycle lives of Example 2 and Comparative Example 4;

FIG. 5A is a graph that compares discharge capacities of Example 3 and Comparative Example 5; and

FIG. 5B is a graph that compares cycle lives of Example 3 and Comparative Example 5.

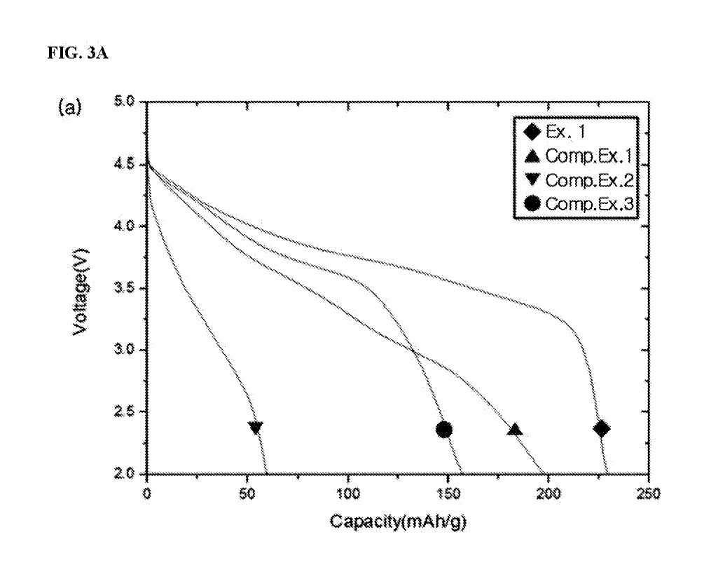

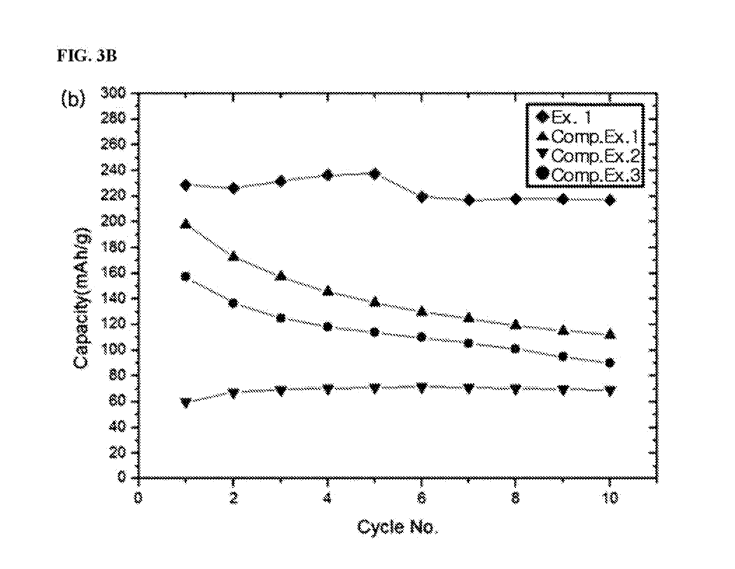

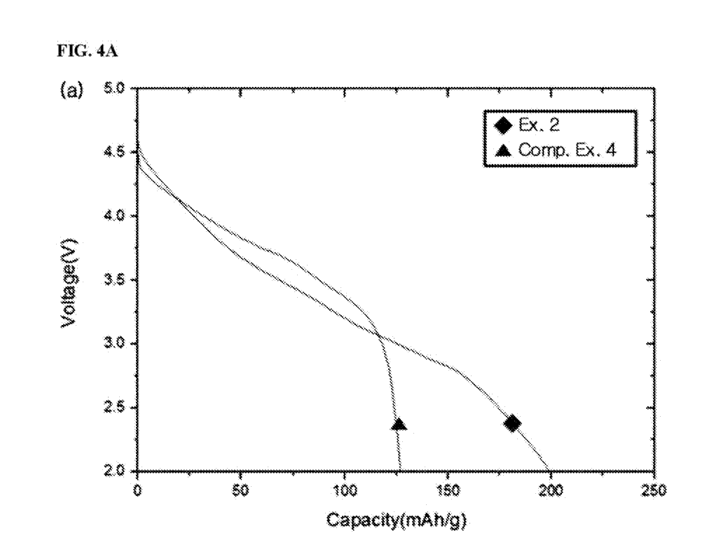

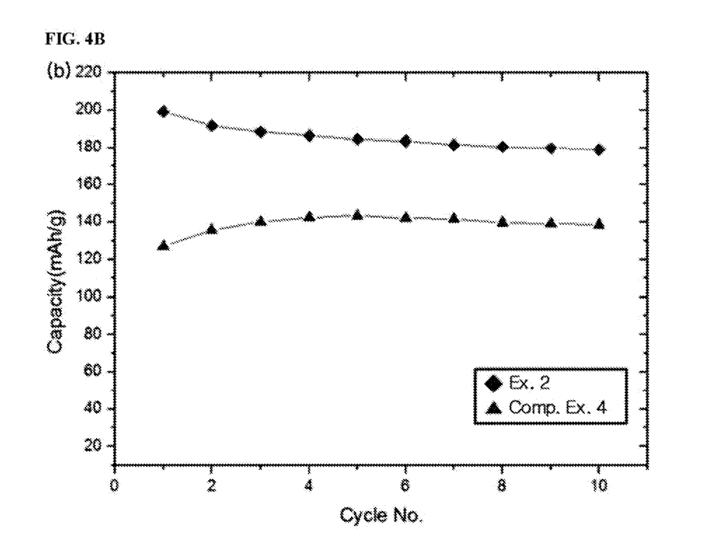

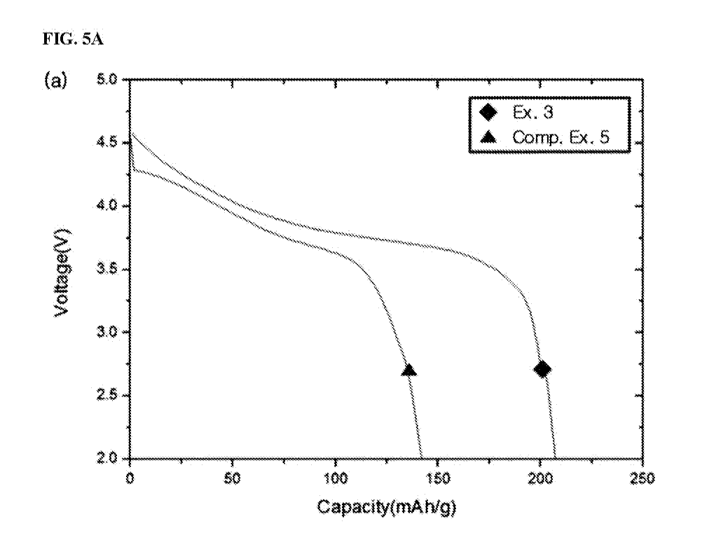

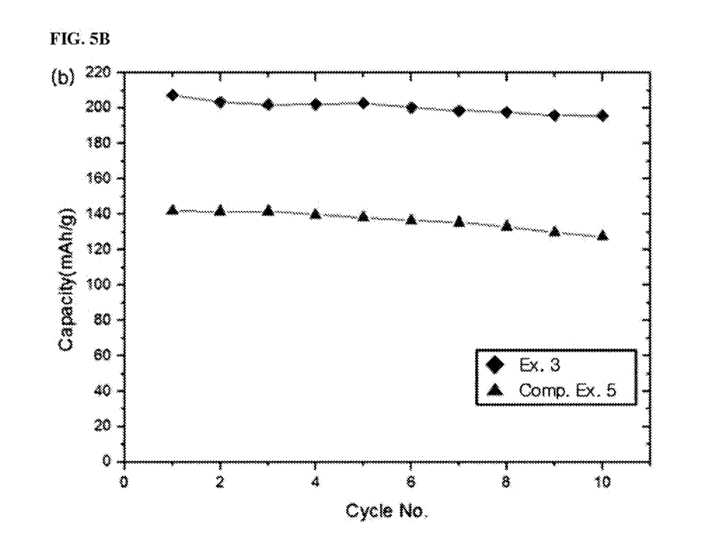

FIGS. 3, 4 and 5 graphically show the discharge characteristics and cycle performance of cells employing nanocomposite cathode active materials produced in Examples 1-3 and Comparative Examples 1-5.

### DETAILED DESCRIPTION OF THE INVENTION

The present invention is directed to a method of producing a layered nanocomposite cathode active material for a lithium secondary battery that has improved electrochemical properties, such as stability, electrode capacity and cycle life in the high-voltage region.

The present invention will now be described in detail.

The method of the present invention provides a nanocomposite cathode active material for a lithium secondary battery, represented by the following formula:

xLi₂MnO₃—(1−x)LiMO₂

wherein M is Niₐ—Mn_{b}—Co_{c}, x is a decimal number from 0.1 to 0.9, and a, b and c are independently a decimal number from 0.05 to 0.9, with the proviso that the sum of a, b and c is equal to 1.

The method of the present invention includes mixing a lithium compound with a manganese compound to prepare Li₂MnO₃ as a first cathode active material, mixing a mixed solution of nickel sulfate/manganese sulfate/cobalt sulfate, a sodium hydroxide solution and aqueous ammonia to prepare a coprecipitated hydroxide represented by (Niₐ—Mn_{b}—Co_{c})(OH)₂ where a, b and c are as defined above, mixing the coprecipitated hydroxide with a lithium compound to prepare a second cathode active material represented by LiMO₂ where M is as defined above, and mixing the first cathode active material with the second cathode active material.

Specifically, the nanocomposite cathode active material is produced by the following procedure.

First, in step (a), a lithium compound and a manganese compound are mixed in such amounts that the molar ratio of the lithium to the manganese is 2:1, and the mixture is heat treated to prepare Li₂MnO₃ as a first cathode active material. At least one dopant selected from the group consisting of Mg, Al, Ca, Ti, V, Cr, Fe, Cu, Zn, Ga, Zr, Mo, Sn, Sb, W and Bi may be added to improve the performance of the first cathode active material. The dopant may be added in an amount of 0.01 to 2% by mole, based on the total moles of the first cathode active material.

If the molar ratio of the lithium compound to the manganese compound is outside the range defined above, stability and electrode capacity of the nanocomposite cathode active material in the high-voltage region may be deteriorated.

The mixture of the lithium compound and the manganese compound is heat treated in air or an oxygen atmosphere at 400 to 900° C., preferably 500 to 800° C., for 3 to 24 hours, preferably 10 to 20 hours. If the heat-treatment temperature and time are below the respective lower limits, large portions of the lithium compound and the manganese compound may remain unbound, resulting in low yield of the first cathode active material. Meanwhile, if the heat-treatment temperature and time are above the respective upper limits, side reactions may occur. As a result of the side reactions, large amounts of impurities having unwanted structures may be formed and the electrochemical properties, such as electrode capacity and cycle life, of the nanocomposite cathode active material may be deteriorated.

The first cathode active material prepared in step (a) has an average particle diameter of 10 to 80 nm, preferably 10 to 50 nm.

The lithium compound may be Li₂CO₃ or LiOH, and the manganese compound may be selected from the group consisting of Mn₂O₃, MnO₂, MnO, Mn₃O₄ and Mn(OH)₂.

Next, step (b) is carried out separately from step (a) to prepare a coprecipitated hydroxide represented by (Niₐ—Mn_{b}—Co_{c})(OH)₂. Specifically, the coprecipitated hydroxide is prepared by reacting a mixed solution of nickel sulfate/manganese sulfate/cobalt sulfate, a sodium hydroxide solution and aqueous ammonia while maintaining the temperature at 40 to 70° C. The pH of the reaction mixture is preferably maintained at 11 to 12.

If the temperature and pH do not fall within the respective ranges defined above, side reactions may occur. As a result of the side reactions, large amounts of impurities having unwanted structures may be formed, indicating low yield of the coprecipitated hydroxide.

The mixed solution is a mixture of nickel sulfate, manganese sulfate and cobalt sulfate in a molar ratio of 0.05-0.9:0.05-0.9:0.05-0.9. The sum of the molar fractions of the metal sulfates is preferably 1. If the sum of the molar fractions of the metal sulfates is more or less than 1, large amounts of impurities having unwanted structures may be formed and the electrochemical properties, such as electrode capacity and cycle life, of the nanocomposite cathode active material may be deteriorated.

The molarity of the sodium hydroxide solution added is 1.5 to 4 times, particularly 2 to 3 times higher than that of the mixed solution. This range helps to improve the yield of the coprecipitated hydroxide.

The coprecipitated hydroxide (Niₐ—Mn_{b}—Co_{c})(OH)₂ prepared in step (b) has an average particle diameter of 10 to 90 nm, preferably 10 to 70 nm.

The coprecipitated hydroxide prepared in step (b) may be washed 5 to 10 times, filtered, and dried to remove unreacted solutions. Any washing solvent capable of removing unreacted solutions may be used without particular limitation. The washing solvent is preferably water, methanol, ethanol or tetrahydrofuran. The filtered coprecipitated hydroxide is dried at 100 to 200° C. for 10 to 24 hours until the water content reaches 10% or less, preferably 5 to 10%. If the water content of the coprecipitated hydroxide exceeds 10%, the coprecipitated hydroxide may not sufficiently react with a lithium compound in the subsequent step, leaving large amounts of impurities and shortening the life of the nanocomposite cathode active material.

Next, in step (c), the coprecipitated hydroxide prepared in step (b) and a lithium compound are mixed in such amounts that the molar ratio of the coprecipitated hydroxide to the lithium of the lithium compound is 1:1, followed by heat treatment to prepare a second cathode active material represented by LiMO₂ (M is as defined above).

At least one dopant selected from the group consisting of Mg, Al, Ca, Ti, V, Cr, Fe, Cu, Zn, Ga, Zr, Mo, Sn, Sb, W and Bi may be added to improve the performance of the second cathode active material. The dopant may be added in an amount of 0.01 to 2% by mole, based on the total moles of the second cathode active material.

The mixture of the coprecipitated hydroxide and the lithium compound is heat treated in air or an oxygen atmosphere at 400 to 900° C., preferably 500 to 800° C., for 3 to 24 hours, preferably 10 to 20 hours. If the heat-treatment temperature and time are below the respective lower limits, large portions of the coprecipitated hydroxide and the lithium compound may remain unbound, resulting in low yield of the second cathode active material. Meanwhile, if the heat-treatment temperature and time are above the respective upper limits, side reactions may occur. As a result of the side reactions, impurities having unwanted structures may be formed large amounts and electrochemical (a) properties, such as electrode capacity and cycle life, may be deteriorated.

The second cathode active material prepared in step (c) preferably has an average particle diameter of 10 to 80 nm, preferably 10 to 60 nm.

Next, in step (d), the first cathode active material prepared in step (a) is mixed with the second cathode active material prepared in step (c), followed by heat treatment to prepare the final nanocomposite cathode active material xLi₂MnO₃—(1−x)LiMO₂.

In the method of the present invention, the amounts of the first and second cathode active materials can be freely selected such that x in xLi₂MnO₃—(1−x)LiMO₂ is within the range of 0.1 to 0.9.

The mixture of the first and second cathode active materials is heat treated in air or an oxygen atmosphere at 900 to 1100° C., preferably 1000 to 1100° C., for 3 to 24 hours, preferably 10 to 20 hours. If the heat-treatment temperature and time are below the respective lower limits, large portions of the first and second cathode active materials may remain unbound, resulting in low yield of the nanocomposite cathode active material. Meanwhile, if the heat-treatment temperature and time are above the respective upper limits, side reactions may occur. As a result of the side reactions, large amounts of impurities having unwanted structures may be formed, and the stability, electrode capacity and cycle life of the nanocomposite cathode active material may be deteriorated.

The use of either first or second cathode active material for the production of the nanocomposite cathode active material may cause deterioration of electrochemical properties, such as electrode capacity and cycle life, by 30 to 70%.

The nanocomposite cathode active material produced in step (d) has an average particle diameter of 10 to 100 nm, preferably 10 to 80 nm. If the average particle diameter of the nanocomposite cathode active material is more than the upper limit or less than the lower limit, poor stability, electrode capacity, cycle life, etc. may be caused.

Preferably, the nanocomposite cathode active material having an average particle diameter of 10 to 80 nm accounts for at least 70% by weight, particularly 70 to 90% by weight of the total weight of the nanocomposite cathode active material. Within this range, the nanocomposite cathode active material has proved to have improved cycle efficiency and thermal stability.

The nanocomposite cathode active material has excellent electrochemical properties in terms of stability, electrode capacity, cycle life, etc. in the high-voltage region. When it is desired to obtain a higher electrode capacity of the nanocomposite cathode active material, x in xLi₂MnO₃—(1−x)LiMO₂ may be set to a higher value. Alternatively, when it is desired to obtain a longer life of the nanocomposite cathode active material, x in xLi₂MnO₃—(1−x)LiMO₂ may be set to a lower value.

The nanocomposite cathode active material can be used to produce a cathode. The cathode further includes a conductive material, a binder, and an electrolyte. The cathode can be used to fabricate a secondary battery. The secondary battery further includes an anode, an electrolyte, and a separator.

The following examples are provided to assist in further understanding of the invention. However, these examples are intended for illustrative purposes only and the invention is not limited thereto. It will be evident to those skilled in the art that various modifications and changes can be made without departing from the scope and spirit of the invention and such modifications and changes are encompassed within the scope of the appended claims.

### EXAMPLES

### Example 1

Mn₂O₃ and Li₂CO₃ were uniformly pulverized by a mechanochemical process, mixed in such amounts that the molar ratio of the manganese to the lithium was 1:2, and heat treated in air at 500° C. for 12 hr to prepare Li₂MnO₃ as a first cathode active material having an average particle diameter of 50 nm. Separately, a mixed solution of NiSO₄/MnSO₄/CoSO₄ in a molar ratio of 0.5:0.3:0.2 was mixed with a sodium hydroxide solution and aqueous ammonia while maintaining the temperature at 60° C., and the resulting mixture was allowed to react at a pH of 11 or less to prepare (Ni_{0.5}Mn_{0.3}Co_{0.2})(OH)₂ as a coprecipitated hydroxide having an average particle diameter of 70 nm. The molarity of the sodium hydroxide solution was adjusted to two times that of the mixed solution of NiSO₄/MnSO₄/CoSO₄. The coprecipitated hydroxide was washed with water ten times, filtered, and dried at 150° C. for 24 hr until the water content reached 5%. The coprecipitated hydroxide and Li₂CO₃ were homogenized, and heat treated in air at 800° C. for 12 hr to prepare LiNi_{0.5}Mn_{0.3}Co_{0.2}O₂ as a homogeneous second cathode active material having an average particle diameter of 60 nm. Thereafter, the cathode active materials Li₂MnO₃ and LiNi_{0.5}Mn_{0.3}Co_{0.2}O₂ were homogenized in a molar ratio of 0.5:0.5 by a mechanochemical process, and the mixture was heat treated in air at 1000° C. for 12 hr to produce 0.5Li₂MnO₃—0.5LiNi_{0.5}Mn_{0.3}Co_{0.2}O₂ as a nanocomposite cathode active material whose average particle diameter was 60 nm and composition was homogeneous.

### Example 2

0.7Li₂MnO₃—0.3LiNi_{0.5}Mn_{0.3}Co_{0.2}O₂ as a nanocomposite cathode active material was produced in the same manner as in Example 1, except that the cathode active materials Li₂MnO₃ and LiNi_{0.5}Mn_{0.3}Co_{0.2}O₂ were mixed in a molar ratio of 0.7:0.3.

### Example 3

0.3Li₂MnO₃—0.7LiNi_{0.5}Mn_{0.3}Co_{0.2}O₂ as a nanocomposite cathode active material was produced in the same manner as in Example 1, except that the cathode active materials Li₂MnO₃ and LiNi_{0.5}Mn_{0.3}Co_{0.2}O₂ were mixed in a molar ratio of 0.7:0.3.

### Comparative Example 1

A nanocomposite cathode active material was produced in the same manner as in Example 1, except that the cathode active materials Li₂MnO₃ and LiNi_{0.5}Mn_{0.3}Co_{0.2}O₂ were mixed at room temperature without heat treatment.

### Comparative Example 2

A nanocomposite cathode active material was produced in the same manner as in Example 1, except that the cathode active material LiNi_{0.5}Mn_{0.3}Co_{0.2}O₂ was not used.

### Comparative Example 3

A nanocomposite cathode active material was produced in the same manner as in Example 1, except that the cathode active material Li₂MnO₃ was not used.

### Comparative Example 4

A nanocomposite cathode active material was produced in the same manner as in Example 2, except that the cathode active materials Li₂MnO₃ and LiNi_{0.5}Mn_{0.3}Co_{0.2}O₂ were mixed at room temperature without heat treatment.

### Comparative Example 5

A nanocomposite cathode active material was produced in the same manner as in Example 3, except that the cathode active materials Li₂MnO₃ and LiNi_{0.5}Mn_{0.3}Co_{0.2}O₂ were mixed at room temperature without heat treatment.

### Comparative Example 6

Mn, Co, Li and Ni were used to prepare a compound represented by M(OH)_{0.2} (M=Mn, Ni, Co). The compound M(OH)_{0.2} and LiOH·H₂O were compressed into pellets, heated in a oven at 400° C. and 600° C. for 5 hr, and cooled to room temperature to produce 0.7Li₂MnO₃·0.3LiMn_{1.6}Ni_{0.2}Co_{0.2}O₄ as a cathode active material.

### Test Example 1

### Characterization of Cathode Active Nanoparticles

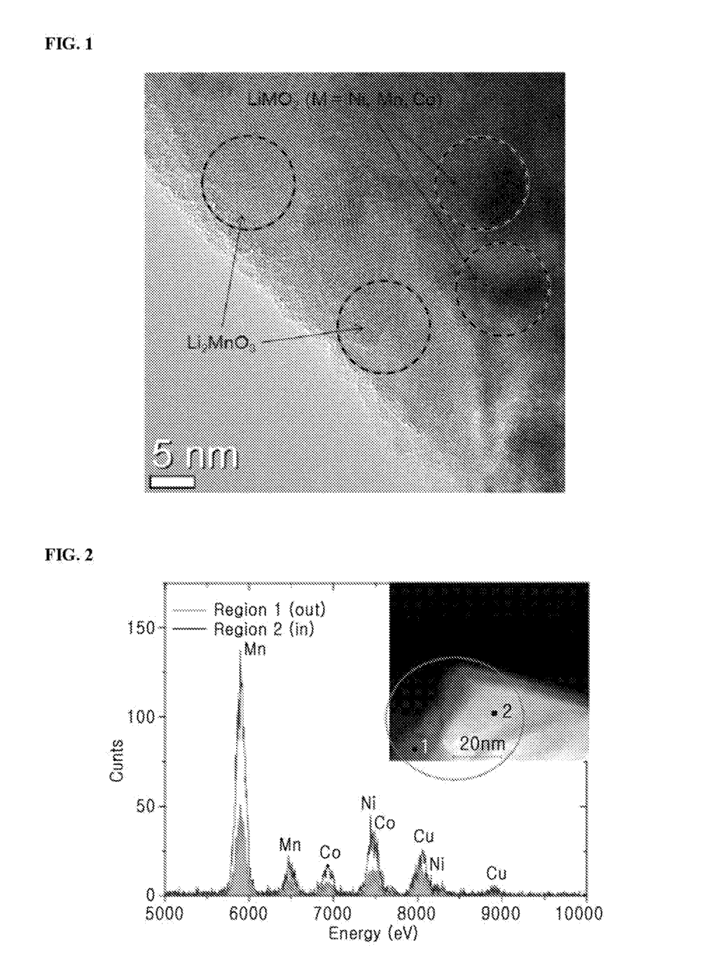

In order to analyze the properties and shape of the nanocomposite cathode active material of Example 1, an image of the nanocomposite cathode active material was taken by high-resolution transmission electron microscopy (HRTEM) and energy dispersive X-ray spectra (EDS) of the nanocomposite cathode active material were measured. The results are shown in FIGS. 1 and 2.

As shown in FIGS. 1 and 2, Li₂MnO₃ and LiMO₂ were homogenized in the nanocomposite cathode active material.

### Test Example 2

### Measurements of Discharge Capacities and Cycle Lives of Cells

0.5 g of each of the nanocomposite cathode active materials produced in Examples 1-3 and Comparative Examples 1-6, 0.03 g of Denka black and 0.04 g of PVDF were mixed. To the mixture was added n-methyl pyrrolidone as a solvent until an appropriate viscosity was obtained. The resulting mixture was cast on a thin aluminum plate, dried, and rolled to produce an electrode. The electrode, a PP separator and lithium metal as a counter electrode were assembled to constitute a half cell for a lithium secondary battery. After a solution of 1 M LiPF₆ in EC/DMC/EMC (1:1:1) was injected into the half cell, the half cell was charged and discharged with a current density of 0.1 C under constant current conditions in the voltage range of 3.0-4.8 V. The charge/discharge behavior and cycle life of the half cell were investigated. The results are shown in FIGS. 3, 4 and 5.

As can be seen from the results in FIGS. 3, 4 and 5, the half cells employing the nanocomposite cathode active materials produced in Examples 1-3 showed higher discharge capacities (FIGS. 3A, 4A and 5A) and longer cycle lives (FIGS. 3B, 4B and 5B) than those employing the nanocomposite cathode active materials produced in Comparative Examples 1-5. These results are believed to be because the nanocomposite cathode active materials of Examples 1-3 had uniform particle sizes and stable structures.

The nanocomposite cathode active material of Comparative Example 6 was confirmed to be comparable to the nanocomposites of Examples 1-3 in terms of discharge capacity and cycle life, but had a lower yield than the nanocomposite cathode active materials of Examples 1-3. Furthermore, according to Comparative Example 6, the nanocomposite cathode active material could not be freely changed to new compositions.

What is claimed is:

1. A method of producing a nanocomposite cathode active material for a lithium secondary battery, represented by the following formula:
xLi₂MnO₃—(1−x)LiMO₂
wherein M is Niₐ—Mn_{b}—Co_{c}, x is a decimal number from 0.1 to 0.9, and a, b and c are independently a decimal number from 0.05 to 0.9, with the proviso that the sum of a, b and c is equal to 1, the method comprising
(a) mixing a lithium compound with a manganese compound, and heat treating the mixture to prepare Li₂MnO₃ as a first cathode active material,
(b) mixing a mixed solution of nickel sulfate/manganese sulfate/cobalt sulfate, a sodium hydroxide solution and aqueous ammonia to prepare a coprecipitated hydroxide represented by (Niₐ—Mn_{b}—Co_{c})(OH)₂ where a, b and c are as defined above,
(c) mixing the coprecipitated hydroxide with a lithium compound, and heat treating the mixture to prepare a second cathode active material represented by LiMO₂ where M is as defined above, and
(d) mixing the first cathode active material with the second cathode active material, and heat treating the mixture.

2. The method according to claim 1, wherein in step (a), at least one dopant selected from the group consisting of Mg, Al, Ca, Ti, V, Cr, Fe, Cu, Zn, Ga, Zr, Mo, Sn, Sb, W and Bi is added in an amount of 0.01 to 2% by mole, based on the total moles of the first cathode active material.

3. The method according to claim 1, wherein in step (a), the heat treatment is performed at 400 to 900° C. for 3 to 24 hours.

4. The method according to claim 1, wherein in step (b), the molarity of the sodium hydroxide solution is 1.5 to 4 times higher than that of the mixed solution.

5. The method according to claim 1, wherein in step (b), the pH is maintained at 11 to 12.

6. The method according to claim 1, further comprising washing, filtering and drying the coprecipitated hydroxide after step (b).

7. The method according to claim 6, wherein the water content of the dried coprecipitated hydroxide is adjusted to 10% or less.

8. The method according to claim 1, wherein in step (c), at least one dopant selected from the group consisting of Mg, Al, Ca, Ti, V, Cr, Fe, Cu, Zn, Ga, Zr, Mo, Sn, Sb, W and Bi is added in an amount of 0.01 to 2% by mole, based on the total moles of the second cathode active material.

9. The method according to claim 1, wherein in step (c), the heat treatment is performed at 400 to 900° C. form 3 to 24 hours.

10. The method according to claim 1, wherein in step (d), the heat treatment is performed at 900 to 1100° C. form 3 to 24 hours.

11. The method according to claim 1, wherein the lithium compounds are Li₂CO₃ or LiOH.

12. The method according to claim 1, wherein the manganese compound is selected from the group consisting of Mn₂O₃, MnO₂, MnO, Mn₃O₄, Mn(OH)₂ and mixtures thereof.

13. The method according to claim 1, wherein the nanocomposite cathode active material produced in step (d) has an average particle diameter of 10 to 100 nm.

14. The method according to claim 1, wherein the nanocomposite cathode active material produced in step (d) having an average particle diameter of 10 to 80 nm accounts for at least 70% by weight of the total weight of the nanocomposite cathode active material.
